(19) United States
(12) Patent Application Publication
(10) Pub. No.: US 2014/0340933 A1
(43) Pub. Date: Nov. 20, 2014

(54) LIGHT GUIDE ELEMENT AND BACKLIGHT MODULE

(71) Applicant: HON HAI PRECISION INDUSTRY CO., LTD., New Taipei (TW)

(72) Inventor: Chen-Han LIN, New Taipei (TW)

(73) Assignee: HON HAI PRECISION INDUSTRY CO., LTD., New Taipei (TW)

(21) Appl. No.: 14/040,504

(22) Filed: Sep. 27, 2013

(30) Foreign Application Priority Data
May 20, 2013 (TW) 102117703

(51) Int. Cl. F21V 8/00

(52) U.S. Cl. CPC G02B 6/0028
USPC 362/610

(57) ABSTRACT

A light guide element includes a wedge-shaped light coupling member and a rectangular light guide plate. The light coupling member includes a first bottom surface, a top surface opposite to the first bottom surface, a light incident surface interconnected between the first bottom surface and the top surface, a first connecting surface parallel with and opposite to the light incident surface, a slanted surface connecting the first connecting surface to the top surface, and a reflection film formed on the top surface and the slanted surface. The light guide plate includes a second bottom surface, a light output surface opposite to the second bottom surface, and a second connecting surface perpendicularly interconnected between the second bottom surface and the light output surface. The second connecting surface connects and overlaps the first connecting surface. The height of the light incident surface is larger than that of the second connecting surface.

### BACKGROUND

1. Technical Field

The present disclosure relates to a light guide element and a backlight module having the light guide element.

2. Description of Related Art

A side-type backlight module includes a light source and a light guide element optically coupled with the light source. However, with ongoing developments in portable electronic devices, the light guide element has been thinner and thinner. Part of the light emitted from the light source may not enter the light guide element. Therefore, the light usage ratio of the light source is low.

Therefore, it is desirable to provide a light guide element and a backlight module having the light guide element, to overcome or at least alleviate the above-mentioned problems.

### BRIEF DESCRIPTION OF THE DRAWINGS

FIG. 1 is a schematic view of a light guide element, according to a first exemplary embodiment.

FIG. 2 is a schematic view of a backlight module, according to a second exemplary embodiment.

FIG. 3 is a top view of the backlight module of FIG. 2.

FIG. 4 is a schematic view of a backlight module, according to a third exemplary embodiment.

### DETAILED DESCRIPTION

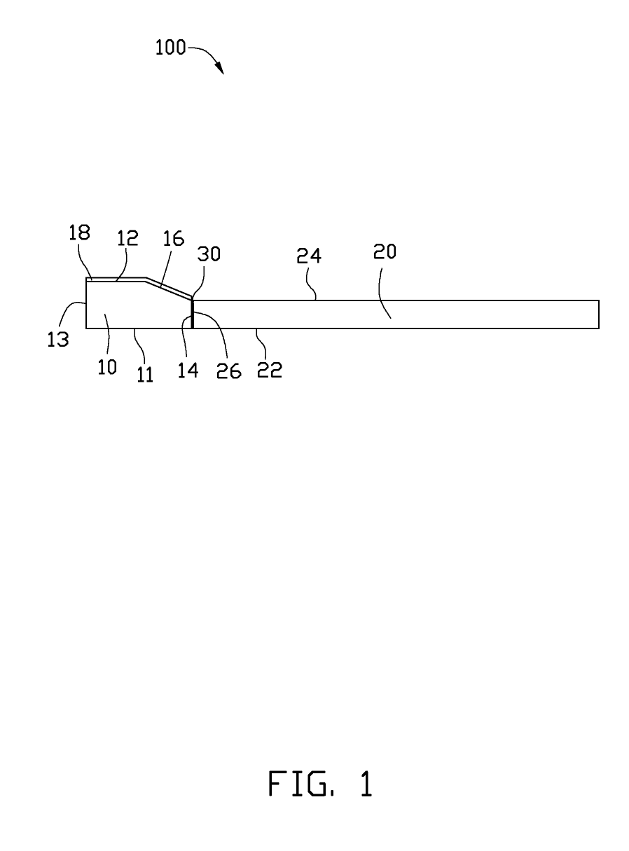

FIG. 1 shows a light guide element 100, according to a first exemplary embodiment. The light guide element 100 includes a light coupling member 10 and a light guide plate 20.

The light coupling member 10 is substantially wedge-shaped. The light coupling member 10 includes a first bottom surface 11, a top surface 12, a light incident surface 13, a first connecting surface 14, a slanted surface 16, and a reflection film 18. The first bottom surface 11 and the top surface 12 are positioned at opposite sides of the light coupling member 10, and the first bottom surface 11 is substantially parallel to the top surface 12. The light incident surface 13 and the first connecting surface 14 are positioned at opposite sides of the light coupling member 10, and the light incident surface 13 is substantially parallel to the first connecting surface 14. The light incident surface 13 is perpendicularly interconnected between the first bottom surface 11 and the top surface 12. The height of the first connecting surface 14 relative to the first bottom surface 11 is less that the height of the light incident surface 13 relative to the first bottom surface 11. The slanted surface 16 connects the top surface 12 to the first connecting surface 14. The reflection film 18 is coated on the slanted surface 16 and the top surface 12, and the reflection film 18 completely covers the slated surface 16 and the top surface 12. In this embodiment, the reflection film 18 is made of high reflective material, such as aluminum or nickel. In another embodiment, the reflection film 18 can be formed on a flexible printed board, and be adhered to the slanted surface 16 and the top surface 12 with the flexible printed board.

The light guide plate 20 is substantially a rectangular plate. The light guide plate 20 includes a second bottom surface 22, a light output surface 24, and a second connecting surface 26. The second bottom surface 22 and the light output surface 24 are positioned at opposite sides of the light guide plate 20, and the second bottom surface 22 is substantially parallel to the light output surface 24. The second connecting surface 26 is perpendicularly interconnected between the first bottom surface 22 and the light output surface 24.

The light coupling member 10 and the light guide plate 20 are two independent pieces. The light coupling member 10 is manufactured by an injection molding process, and the light guide plate 20 is manufactured by an imprinting process. When in use, the first connecting surface 14 is connected to the second connecting surface 26. The first connecting surface 14 and the second connecting surface 26 are completely overlapped. The first bottom surface 11 is coplanar with the second bottom surface 22, thereby a common reflection surface (including the first bottom surface 11 and the second bottom surface 22) of the light guide element 100 is formed in the bottom. In this embodiment, the height of the light incident surface 13 (the distance between the first bottom surface 11 and the top surface 12) is about 0.7 millimeters (mm). Each of the height of the first connecting surface 14 and the height of the second connecting surface 26 (the distance between the second bottom surface 22 and the light output surface 24) is about 0.5 mm.

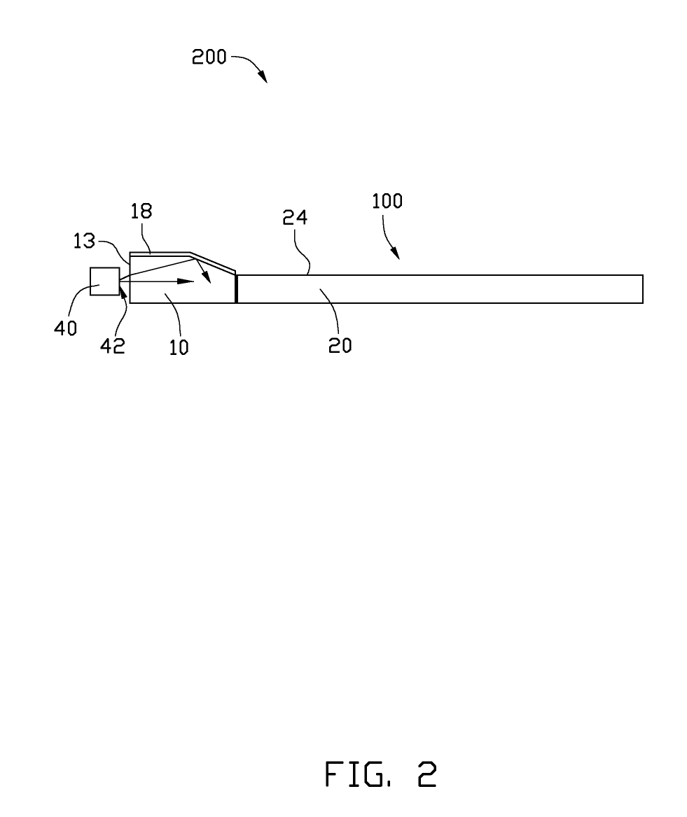

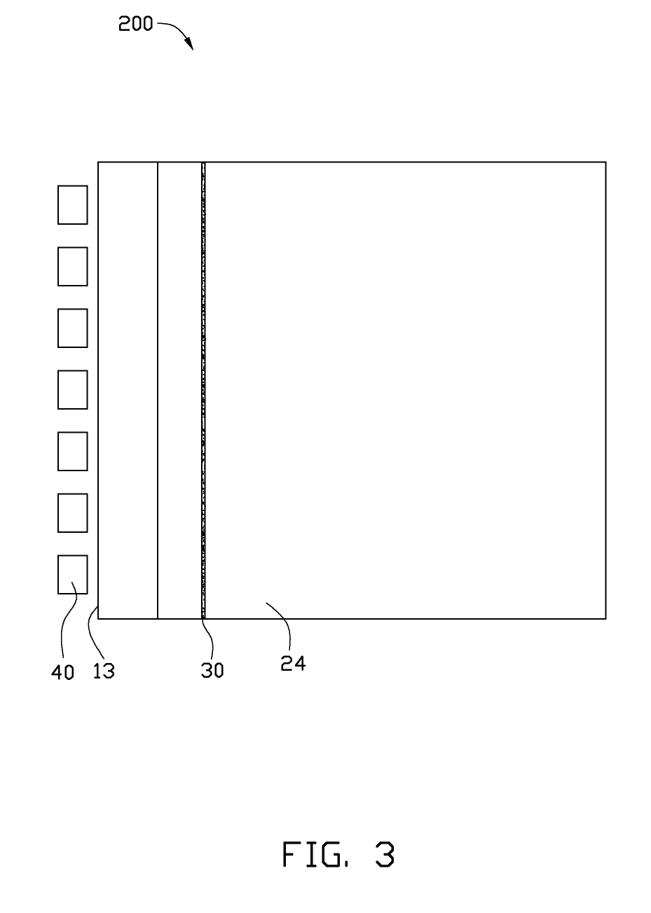

FIGS. 1-3 show a backlight module 200 according to a second exemplary embodiment. The backlight module 200 includes the light guide element 100 of the first embodiment and a number of light sources 40. The light coupling member 10 is assembled with the light guide plate 20 by optical coupling glue 30. In detail, the optical coupling glue 30 is in contact with the light coupling member 10 and the light guide plate 20, and the first connecting surface 14 is connected to the second connecting surface 26 through the optical coupling glue 30. The first connecting surface 14 and the second connecting surface 26 are completely overlapped. The first bottom surface 11 is coplanar with the second bottom surface 22. The optical coupling glue 30 has a refractive index which is the same as those of the light coupling member 10 and the light guide plate 20, and does not influence the path of light transmitted in the light guide element 100. The light sources 40 is positioned adjacent to the light incident surface 13, and each of the light emitting surfaces 42 of the light sources 40 faces the light incident surface 13. In this embodiment, each of the light sources 40 is a light emitting diode (LED).

When in use, light emitted from the light sources 40 enters the light coupling member 10 through the light incident surface 13, and is then guided into the light guide plate 20 by the light coupling member 10, and is further scattered and reflected in the light guide plate 20, and finally emits from the light guide plate 20 through the light output surface 24.

More light emitted from the light sources 40 can be introduced and concentrated into the light guide plate 20 because the height of the light incident surface 11 is larger than that of the second connecting surface 26. Therefore, the light usage ratio of the light sources 40 is increased. In addition, as the reflection film 18 is formed on the slanted surface 26 and the top surface 12, leakage of light from the slanted surface 26 and the top surface 12 is avoided, and the greater concentration of light into the light guide plate 20 results in enhancement of the light usage ratio of the light sources 40.

In another embodiment, the backlight module 200 may include only one light source 40 and become more compact.

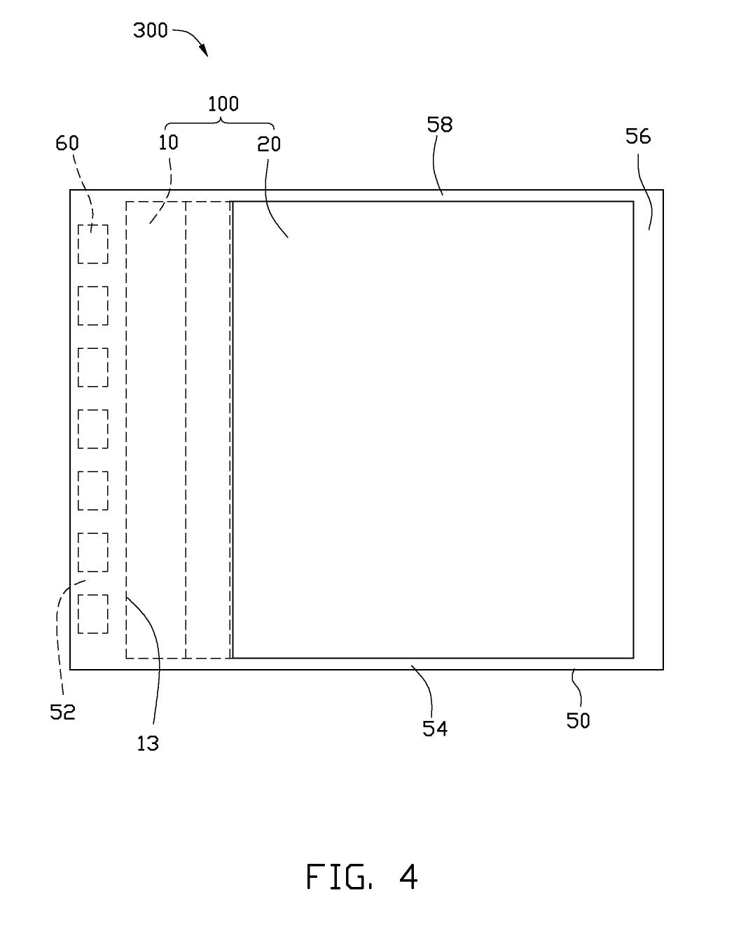

FIGS. 1 and 4 show a backlight module 300 according to a third exemplary embodiment. The backlight module 300 includes the light guide element 100 of the first embodiment, a frame 50, and a number of light sources 60.

The frame 50 is substantially rectangular. The frame 50 includes a first sidewall 52, a second sidewall 54, a third sidewall 56, and a fourth sidewall 58. The first sidewall 52, the second sidewall 54, the third sidewall 56, and the fourth sidewall 58 are perpendicularly connected to each other end-to-end.

The light sources 60 are arranged in a straight line and are embedded in the first sidewall 52. Opposite ends of the optical coupling member 10 are fixed to the second sidewall 54 and the fourth sidewall 58, respectively, and the light incident surface 13 is fixed to the first sidewall 52. Thus, the optical coupling member 10 is mounted in the frame 50. Three side surfaces of the light guide plate 20 are fixed to the second sidewall 54, the third sidewall 56 and the fourth sidewall 28, respectively. Thus, the light guide plate 20 is mounted in the frame 50. In this situation, the first connecting surface 14 directly abuts the second connecting surface 26, and the first connecting surface 14 and the second connecting surface 26 are completely overlapped. The first bottom surface 11 is coplanar with the second bottom surface 22. The frame 50 completely covers the top surface 12, the slanted surface 16 and the light sources 40, and the light output surface 24 is totally exposed at the frame 50. Therefore, the optical coupling glue 30 can be omitted.

Advantages of the backlight module 300 of the third embodiment are similar to those of the backlight module 200 of the second embodiment. Furthermore, the light coupling member 10 is assembled with the light guide plate 20 through the frame 50, and the optical coupling glue 30 is omitted. Thus, light can be more easily transmitted in the light guide element 300. In addition, the frame 50 completely covers the top surface 12, the slanted surface 16, and the light sources 40, light can only emits from the light guide element 300 through the light output surface 24 on one hand, and it makes the light guide element 300 have an aesthetic appearance on the other hand.

Even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A light guide element comprising:
a wedge-shaped light coupling member comprising a first bottom surface, a top surface opposite to the first bottom surface, a light incident surface perpendicularly interconnected between the first bottom surface and the top surface, a first connecting surface parallel with and opposite to the light incident surface, a slanted surface connecting the first connecting surface to the top surface, and a reflection film formed on the top surface and the slanted surface; and
a rectangular light guide plate comprising a second bottom surface, a light output surface opposite to the second bottom surface, and a second connecting surface perpendicularly interconnected between the second bottom surface and the light output surface, the second connecting surface connected to the first connecting surface, the first connecting surface and the second connecting surface completely aligned and overlapped with each other, the first bottom surface being coplanar with the second bottom surface, and the height of the light incident surface relative to the first bottom surface being larger than that of the second connecting surface relative to the second bottom surface.

2. The light guide element of claim 1, further comprising optical coupling glue, wherein the first connecting surface is connected to the second connecting surface through the optical coupling glue.

3. The light guide element of claim 1, wherein the height of the light incident surface is about 0.7 millimeters, and the height of the second connecting surface is about 0.5 millimeters.

4. The light guide element of claim 1, wherein the light coupling member is manufactured by an injection molding process, and the light guide plate is manufactured by an imprinting process.

5. A backlight module comprising:
a light guide element comprising:
a wedge-shaped light coupling member comprising a first bottom surface, a top surface opposite to the first bottom surface, a light incident surface perpendicularly interconnected between the first bottom surface and the top surface, a first connecting surface parallel with and opposite to the light incident surface, a slanted surface connecting the first connecting surface to the top surface, and a reflection film formed on the top surface and the slanted surface; and
a rectangular light guide plate comprising a second bottom surface, a light output surface opposite to the second bottom surface, and a second connecting surface perpendicularly interconnected between the second bottom surface and the light output surface, the second connecting surface connected to the first connecting surface, the first connecting surface and the second connecting surface completely aligned and overlapped with each other, the first bottom surface being coplanar with the second bottom surface, and the height of the light incident surface relative to the first bottom surface being larger than that of the second connecting surface relative to the second bottom surface; and
at least one light source adjacent to the light incident surface, and each of light emitting surface of the at least one light source facing the light incident surface.

6. The backlight module of claim 5, further comprising optical coupling glue, wherein the first connecting surface is connected to the second connecting surface through the optical coupling glue.

7. The backlight module of claim 6, wherein the height of the light incident surface is about 0.7 millimeters, and the height of the second connecting surface is about 0.5 millimeters.

8. The backlight module of claim 7, wherein the light coupling member is manufactured by an injection molding process, and the light guide plate is manufactured by an imprinting process.

9. The backlight module of claim 5, further comprising a frame, wherein the light coupling member is fixed in the frame, the frame entirely covers the top surface, the slanted surface, and the at least one light sources, the light guide plate is fixed in the frame, the light output surface exposed at the frame, and the first connecting surface directly abuts the second connecting surface.

10. The backlight module of claim 9, wherein the frame comprises a first sidewall, a second sidewall, a third sidewall, and a fourth sidewall, the four sidewalls are perpendicularly connected to each other end-to-end, the at least one light source is embedded in the first sidewall, opposites of the light coupling member are fixed to the second sidewall and the fourth sidewall respectively, three side surfaces besides the second connecting surface are fixed to the second sidewall, the third sidewall and the fourth sidewall respectively.

11. The backlight module of claim 10, wherein the height of the light incident surface is about 0.7 millimeters, and the height of the second connecting surface is about 0.5 millimeters.

12. The backlight module of claim 11, wherein the light coupling member is manufactured by an injection molding process, and the light guide plate is manufactured by an imprinting process.
